(19) United States
(12) Patent Application Publication
(10) Pub. No.: US 2004/0260836 A1
(43) Pub. Date: Dec. 23, 2004

(54) Domain name area code information system

(76) Inventor: Roger N. Fearing, Woodland Hills, CA (US)

Correspondence Address: Merek, Blackmon & Voorhees, LLC, 673 S. Washington St., Alexandria, VA, 22314, US

(21) Appl. No.: 10/846,671

(22) Filed: May 17, 2004

Related U.S. Application Data
(60) Provisional application No. 60/470,429, filed on May 15, 2003.

(51) Int. Cl. G06F 15/16

(52) U.S. Cl. 709/245

(57) ABSTRACT

The present invention relates to a top level domain for storing, indexing and organizing information about area codes by reserving the second level domain names that consist of the area code numbers. Namely, for a particular top level domain such as “.key”, the second level domain names “000.key” through “999.key” would be reserved for use as domain names for the area code information sites.

This application claims priority to U.S. patent application Ser. No. 60/470,429 filed May 15, 2003, which is hereby incorporated by reference.

### BACKGROUND OF THE INVENTION

A. Field of the Invention

The present invention relates to a domain organized to provide locale specific information based on the codes.

B. Description of the Prior Art

The internet has the unique characteristic of shrinking world communication is a “free” environment where it is as simple and as fast to communicate with a website in China as it is to communicate with a computer in the house next door. While the advantages in sharing information around the world at the speed of light is certainly advantageous, it is often desirable to find information about a particular geographically restricted location. An internet user looking for a store to have his carpet installed is certainly not interested in finding out about a sale some 6000 miles away. While it may be “free” to communicate around the world, it is not necessarily free to have good and/or services ordered over the internet delivered to the user.

There currently exists internet based “yellow pages” that have city, state or other fields to limit the data coming back to the user. A user can look for a particular good or service and limit the “hits” returned by city, state or other limitation. This is certainly a valuable tool.

However, the current invention presents a unique way of approaching the storage and organization of information. The current invention teaches a top level domain, for instance “.key” in which every possible area code, namely 000 through 999 in the United States, is registered as an individual domain name (“000.key through 999.key”). A user wishing to find information specific to a particular area code can enter the domain name associated with the desire area code to find information about that area code. For instance, in Northern Virginia, entering 703.key into the address block of a browser will forward the user to a website (“http://703.key”) that has information and/or services pertaining to the 703 area code. The use of a domain name equal to the area code collected at a particular top level domain (“.key”) means that a user using any browser at any location can instantly access the area code specific website by entering the associated domain name in the browser address block.

None of the above inventions and patents, taken either singly or in combination, is seen to describe the instant invention as claimed.

### SUMMARY OF THE INVENTION

Accordingly, it is a principal object of the invention to provide a catalogue of information specific to an area code by committing a particular top level domain to have the entire range of possible area codes registered as second level domain names.

It is another object of the invention to provide each area code with a domain name on a particular top level domain for easy access by users to information about goods, services, and other area code specific information within a desired area code.

It is a further object of the invention to provide a top level domain dedicated to the servicing of area code domains.

Still another object of the invention is to reserve all of the domain names equivalent to the potential area codes in a particular country for use in organizing information pertaining to the particular area codes by domain names associated with the area codes.

It is a still further object of the invention to provide a top level domain for receiving inquiries about an area code and indexing information about the area codes by at least a second level domain name comprising the area code and the top level domain name.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### DETAILED DESCRIPTION OF THE PREFERRED EMBODIMENT(S)

The present invention relates to a top level domain for storing, indexing and organizing information about area codes by reserving the second level domain names that consist of the area code numbers. Namely for a particular top level domain such as “.key”, the second level domain names “000.key” through “999.key” would be reserved for use as domain names for the area code information sites.

As the internet continues to become more and more popular and pervasive throughout the world, there will continue to exist a need to filter information pertinent only to the locale of the user. A user browsing the internet for Chinese take out food would certainly not be interested under most circumstances in restaurants in China, or even 100 miles away from his current location.

While certain sites have developed which organize information within the site based on geographic or geopolitical locations, these websites have their limitations. For instance a number of “yellow page” type on-line directories exist that will allow query fields to be used to limit the “hits” to a certain city or state. However, these on-line directories require the memorization of the websites and are usually limited in their content to those types of information, goods and services found in a yellow pages type directory.

There currently exists a need for a more flexible system of organization for organizing information based on the area code of the desired area. By dedicating a top level domain to the registration of all potential second level domain names to those comprising the area codes (000-999) and the top level domain name (“.key”), an array of domain names can be formed (i.e,. “000.key” through “999.key”) for easy access to information pertaining to the particular area code.

Because the names formed are domain names, which will be registered in the appropriate domain name server, a user using any browser from any location will be able to find information on the area code by entering the domain name in the address block of the browser, such as “703.key” for the Northern Virginia area. It is significant that unlike on-line directories or even search engines or key words searches, the start of the search for information on a particular area code is a properly registered domain name. Not only does this provide incredible flexibility in the content and type of information available at the website, but the query and the website are one and the same.

Once the query “703.key” is entered into the browser address line, the browser is forwarded by a domain name server to the website containing information, indexes, or appropriate forwarding information to present the user with information about the particular area code. The information could be in the form of a menu or mark up language allowing the user to graphically select particular information for the area codes, such as good, services or other information particular to that area code. One skilled in the art would recognize that instead of providing hypertext or other menu selection ability, spaces could be provided to enter the information desired to additional select particular information about the area code. Additionally, the website could either forward the browser to another website about the area code or provide links to other websites instead of providing information directly in the website.

Because the name of the information site are all reserved on a particular top level domain, users will come to know that information about any area code can be determined by the use of a standard query “areacode.key”. The use of domain names consisting of the area code provides both a simple method of remembering the name of the site and allows for additional services to be offered, such as e-mail addresses (e.g., “bill@703.key”) and the use of standard sub levels for the domain names for standard queries, such as restaurants.703.key to find restaurants or camping.703.key to find camping facilities in the geographic area. This is all simplified by dedicating the second level domain names of the top level domain to area codes. Instead of having to provide cumbersome information blocks at a particular website, which could bottleneck with too many simultaneous hits, the use of domain names allows load sharing among different resources which the browser will be directed to by the responsible domain name server.

If necessary each domain name, and thus each area code, could be provided on a different server to balance the load of the inquiries as the system becomes more popular.

One skilled in the art would also appreciate that a lower level domain could be used without departing from the scope of the invention, such as “703.key.com,” etc., but is much less preferred because it is much easier to remember a simple top level domain than the myriad of permutations possible in a second level domain as the root.

It is to be understood that the present invention is not limited to the sole embodiment described above, but encompasses any and all embodiments within the scope of the following claims.

I claim:

1. A method of organizing directory information by dedicating a domain in the form of area_code.domain.

2. The method of organizing a directory in claim, wherein the area_code of said area_code.domain is a three digit number between 0 and 999 representing a particular area code.

3. The method of organizing a directory in claim, wherein the domain of said area_code.domain is a top level domain.

4. A top level domain for organizing information wherein at least one first level subdomain is a three digit number corresponding to information about businesses within the telephone area code represented by said three digit number.

5. A method of organizing information on a network by providing a dedicated domain having at least 25 percent of the first level domains having the form of #.dom, where the # of said #.dom represents a telephone area code, and the .dom of said #.dom represents a top level domain.
